(19) United States
(12) Patent Application Publication
(10) Pub. No.: US 2022/0410117 A1
(43) Pub. Date: Dec. 29, 2022

(54) Packing Element Placed Inside a Chamber to Promote Contact Between Circulating Fluids

(71) Applicant: TOTALENERGIES RAFFINAGE CHIME, COURBEVOIE (FR)

(72) Inventors: Sébastien Decker, Octeville sur Mer (FR); Jean-Christophe Raboin, Chaumont sur Tharonne (FR); Céline Derouin, Le Havre (FR)

(21) Appl. No.: 17/621,564

(22) PCT Filed: Jun. 25, 2020
(86) PCT No.: PCT/EP2020/067780

§ 371 Date: Dec. 21, 2021

(30) Foreign Application Priority Data
Jun. 26, 2019 (FR) 1906921

(51) Int. Cl. B01J 19/32; B01J 8/00

(52) U.S. Cl. CPC B01J 19/32; B01J 8/005; B01J 2219/32213; B01J 2219/32237; B01J 2208/00991; C10G 11/18

(57) ABSTRACT

The invention relates to a lining (10) intended to be positioned inside a chamber (1) to promote contact between fluids circulating inside said chamber, said lining comprising a plurality of separate criss-crossing strips (12): —first strips (12.1i) parallel to a first direction (D1) and defining a plurality of first planes spaced apart from each other, —second strips (12.2i) parallel to a second direction (D2) forming an angle with the first direction (D1) and defining a plurality of second planes spaced apart from each other. In each first plane, a free space separates two first adjacent strips I a direction perpendicular to the first direction and receives a second strip, the first and second strips being secured together. Each separate strip of at least one stage is perforated (12) and selected from a strip made from a stamped metal sheet and a strip made from an expanded metal sheet.

The invention relates to an internal packing element used to promote contact between fluids circulating within a chamber. The invention is in particular more suited to promoting contact between fluids circulating in counter-current fashion inside a chamber in the field of petrochemicals, chemistry, refining in processes requiring intimate contact between fluids, and most particularly for obtaining intimate contact between a gas and a liquid or solid particles in circulation.

In the field of petrochemicals, the use of internal packing elements is known and well established. Packing elements of this kind are used in particular to promote contact between a liquid and a gas, or between solid particles and a gas, in particular in stripping chambers.

Stripping is understood here as the operation consisting in using a gaseous fluid to extract hydrocarbons trapped in the porous network of a solid, contained between grains of solid (for example a catalyst), or using a gas to extract low-molecular-weight molecules contained in a liquid.

This type of application is encountered for example in fluid catalytic cracking (FCC) units. The hydrocarbon feedstock of such a unit is brought into contact with a catalyst composed of porous solid microparticles to undergo a cracking reaction. After this reaction, the catalyst is separated as quickly as possible from the cracked products in order to avoid secondary reactions. The enclosure or chamber in which this operation is carried out is commonly referred to as a disengager. After this separation, cracking products remain trapped in the porous network of the catalyst and in the inter-granular space. These trapped cracking products are recovered by means of a stripping operation using gas injected counter to the stream of catalyst. This operation takes place in an enclosure commonly referred to as a stripper. In order to improve the efficiency of this operation, internal elements can be present in this enclosure to promote contact between the stripping gas and the catalyst.

For example, WO200035575A1 thus describes a packing element comprising interleaved blades: the blades extend in parallel planes; certain blades extend parallel to a first direction, other blades extend parallel to a second direction, and blades parallel to the first direction defining a given plane are spaced apart from one another, a blade extending parallel to the second direction being inserted into each one of these spaces. These blades can be solid or perforated. These arrangements of blades are gathered into small modules to make them easier to install. Multiple stages of modules can be superposed. The orientation thereof can be changed at each module level.

This type of packing element yields good results but remains heavy and costly to produce. In addition, the number of beds of this type of packing element can be large in order to obtain optimal efficiency. For example, during modifications of existing FCC units, the fact that the size of the stripper is fixed, and is sometimes small, leads to incomplete stripping, which could be improved with optimization of the technology. Moreover, improving the efficiency of this type of packing element in an FCC unit can also result in a reduction of the necessary quantity of stripping gas, which brings about a saving in terms of operational cost or even in terms of energy consumption of the unit.

There is therefore a need to improve packing elements in order to promote contact between fluids circulating inside a chamber.

A first subject of the invention relates to a packing element designed to be positioned inside a chamber to promote contact between fluids circulating inside this chamber, particularly in counter-current fashion, said packing element comprising at least two stacked stages, each stage being formed of a plurality of distinct blades:
a plurality of first blades extend parallel to a first direction and define a plurality of first planes spaced apart from one another,
a plurality of second blades extend parallel to a second direction forming an angle with the first direction and define a plurality of second planes spaced apart from one another, and in which, in each first plane, a free space separates two adjacent first blades in a direction perpendicular to the first direction and receives a second blade, the first and second blades being rigidly connected to one another, in particular at contact points where they intersect.

The first and second blades of the packing element are thus interleaved, which promotes contact between fluids passing through this packing element. According to the invention, each distinct blade of at least one stage is perforated and is chosen from a blade made from stamped metal sheet and a blade made from expanded metal sheet. The presence of perforations makes it possible to further promote contact between fluids, in particular between a rising gas passing through them and a descending fluid trickling over the blades, wherein this descending fluid can be a liquid or solid particles. More precisely, one portion of the descending liquid or solid particles thus passes through the perforations; the other portion of the fluid or of the particles trickles over the blades, wherein this other portion can represent half or more of the liquid or of the particles.

Advantageously, all of the blades of at least one stage can be made from stamped metal sheet or all of the blades of at least one stage can be made from expanded metal sheet. In the case of an expanded metal sheet, the longitudinal direction of the blade can be perpendicular to the direction in which the metal sheet is stretched during production thereof.

Advantageously, the perforations of a blade of said at least one stage can represent 15% to 95% of the surface area of the blade, this surface area being defined as a surface area parallel or substantially parallel to a plane defined by a plurality of blades. When the blade is made from stamped metal sheet, the perforations can represent 15 to 30% of the surface area of the blade. When the blade is made from expanded metal sheet, the perforations can represent 30 to 95% of the surface area, in particular 40 to 90% of the surface area of the blade.

Advantageously, each perforated blade of said at least one stage has at least one non-planar face, this face being defined as a face parallel or substantially parallel to a plane defined by a plurality of blades, which can promote contact between the fluids.

Advantageously, each perforated blade of said at least one stage can comprise one or more of the following features:
the perforations of a given blade are spaced apart, in particular regularly, along the length of the blade, for more even contact between the fluids passing through the perforations.
the adjacent and longitudinally spaced apart perforations of a given blade are offset with respect to one another in a transverse direction, perpendicular to the direction of the blade, by a distance smaller than the dimension of a perforation in said transverse direction; this can make it possible to promote mixing of the fluids.

In one embodiment, each perforated blade of said at least one stage can be a blade made from expanded metal sheet. A blade made from expanded sheet is obtained by cutting and stretching a coil or a plate of metal in a knife press. This technique makes it possible to obtain a perforated blade the surfaces of which are not planar owing to the stretching of the cut (i.e. pierced) portions. In another embodiment, each perforated blade of said at least one stage can be a blade formed of a part made from expanded metal sheet surrounded by a frame to which it is attached. The perforations can then cover a large surface area of the blade, with the frame making it possible to adequately stiffen the blade to ensure its mechanical integrity.

The part made from expanded sheet can have parallel or substantially parallel perforations that extend in a direction perpendicular to the longitudinal direction of the blade.

In another embodiment, each perforated blade of said at least one stage can be a blade made from stamped metal sheet, each perforation of which is topped by a deflector formed from the material stamped to produce the perforation and connecting two opposite edges of the perforation, each deflector defining, with the plane of the blade, a passage the axis of which is parallel to the direction in which the blade extends. This configuration makes it possible to improve contact between the fluids.

Advantageously, the deflectors of a given blade can be located on the same side of the blade; this can make it possible to promote contact between the fluids passing through the perforations of the blade without however generating a preferential passage, in particular when the deflectors are transversely offset with respect to one another.

Advantageously, for better mixing, the deflectors of blades defining a given plane within said at least one stage can be located on the same side of said plane. In particular, the deflectors of the first blades can be located on the same side of the planes defined by said first blades, and the deflectors of the second blades can be located on the same side of the planes defined by said second blades.

In general, the blades of one stage can be contained in a volume having an axis, and the first and second directions form a predefined angle with said axis. This angle can for example be 30 to 70°, for example 35 to 55°.

Advantageously, the deflectors of the perforations of the first and second blades of said at least one stage can be located on the same side of the blades in a direction of the axis of the volume containing the blades.

The packing element according to the invention includes at least two stages of blades, preferably at least three stages or even more. A packing element can for example comprise six stages or more of blades.

Each one of these stages can consist of perforated blades as described previously. In particular, one or more stages can consist of stamped perforated blades and one or more stages can consist of perforated blades made from expanded sheet, with or without a frame.

As a variant, a packing element can comprise at least one stage chosen from a stage of blades formed of solid plates and a stage of blades formed of corrugated solid plates.

A packing element according to the invention can thus comprise multiple stages of different types of blade. It is for example possible to alternate stages of perforated blades according to the invention with stages of blades formed of solid plates and stages of blades formed of corrugated solid plates. The invention is not limited to a particular configuration of each of the stages forming a packing element, provided that at least one of the stages has perforated blades as described previously.

The packing element according to the invention comprises at least two stacked stages, in particular stacked in a stacking direction that forms an angle with each of the first and second directions. Each stage then extends between two planes that are perpendicular or substantially perpendicular to the stacking direction.

Two stacked adjacent stages can rest directly one on the other or can be spaced apart from and rigidly connected to one another by spacers.

In addition, the first and second blades of a stage can be angularly offset, by rotation about a stacking direction, with respect to the first and second blades of one or more other stages. This makes it possible to promote contact between the fluids circulating in counter-current fashion. This angular offset can be 30 to 150°, preferably 60 to 120° or more preferably 90°.

The invention also relates to a chamber for bringing into contact fluids circulating in a fluid circulation direction, inside which there is arranged at least one packing element according to the invention, said packing element being arranged so that the first and second directions form a predefined angle with said fluid circulation direction. This angle can be as described above.

In particular, when the blades of at least one stage have deflectors, the deflectors of the perforations of the first and second blades can be located on the same side of the blades in the fluid circulation direction, in particular in a direction towards the top of the chamber. In other words, the deflectors can advantageously be on that side of the blades over which the descending liquid or particles trickle(s). This can force a rising gas stream to change direction and to encounter more descending fluid or particles. A portion of the descending fluid (liquid or solid particles) will pass through the space below the deflector and fall onto the following blade via the perforations in the blade, and as it falls will be brought into so counter-current contact with the rising gas stream (for example the stripping gas), a portion of which will pass through the perforations in the opposite direction. The descending fluid passing around these deflectors will then encounter the rising gas stream coming from the perforations and will also, to a certain extent, be stripped by this gas stream. The gas stream arriving on the top of the blade will be able to disturb the flow of the descending fluid and limit continuous trickling in contact with a blade, since such continuous trickling is not conducive to gas/fluid contact.

This chamber can in particular be a chamber of a stripping device, in particular of a fluid catalytic cracking unit. The chamber can equally be a portion of a pipe, in particular of a withdrawal well of a regenerator. In this case, improving the contact between the gas used and the catalyst particles present in the withdrawal well makes it possible to maintain proper aeration of these catalyst particles in order to ensure good fluidization and circulation thereof prior to re-injection into the riser of an FCC unit.

The invention will now be described with reference to the appended non-limiting drawings, in which:

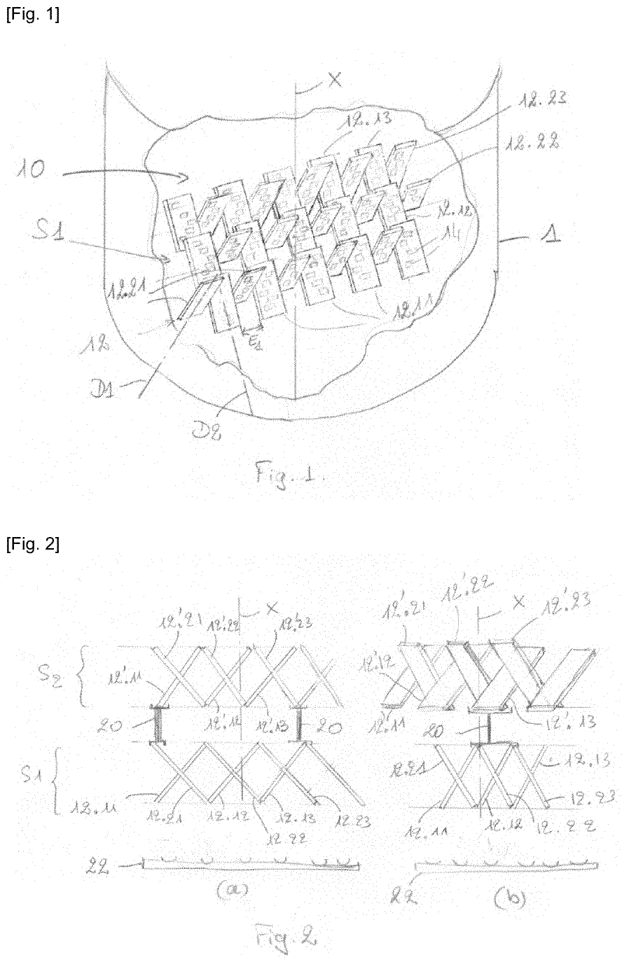

FIG. 1 partially shows a chamber provided with a packing element according to one embodiment of the invention.

FIG. 2 (a) and (b) show side views of two stages of a packing element according to two embodiments of the invention.

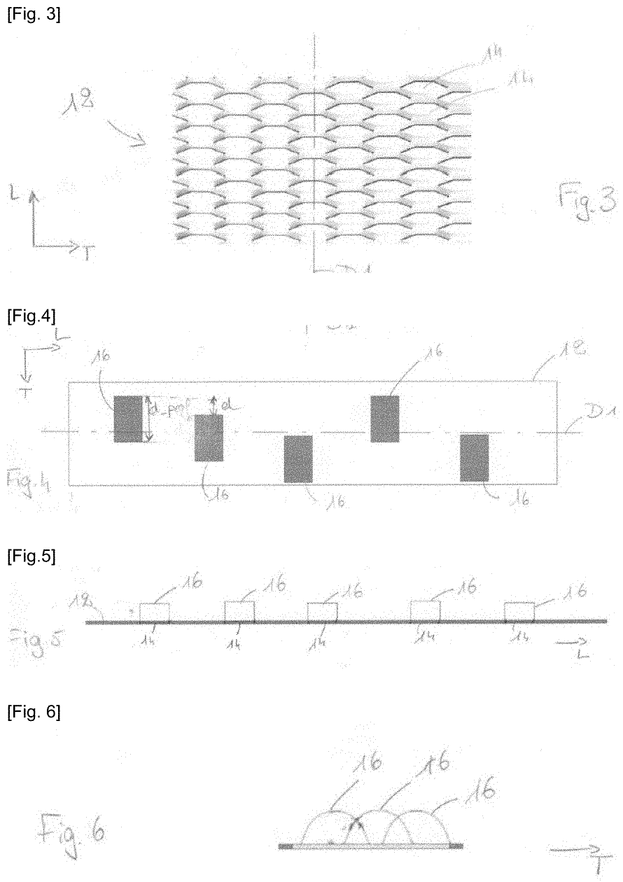

FIG. 3 partially shows a blade of a packing element according to one embodiment of the invention.

FIG. 4 schematically shows a front view of a blade of a packing element according to another embodiment of the invention.

FIG. 5 schematically shows a side view of the blade in FIG. 4, in the longitudinal direction thereof.

FIG. 6 schematically shows a side view of the blade in FIG. 4, in the transverse direction thereof.

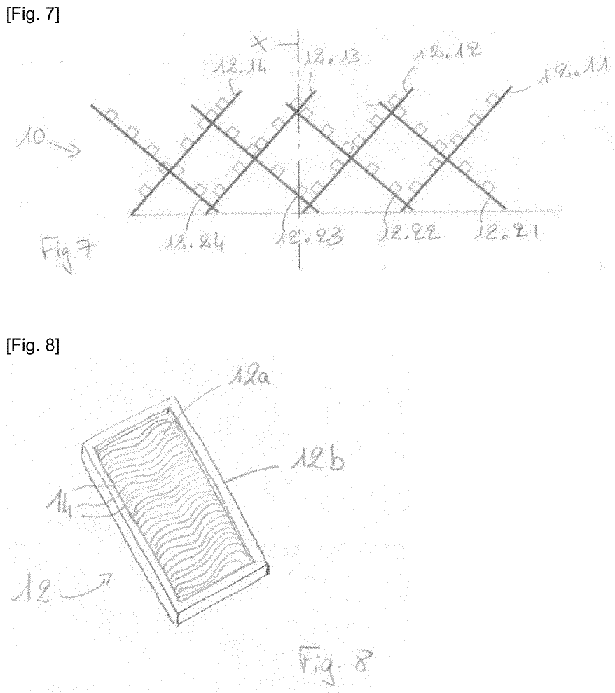

FIG. 7 schematically shows a side view of first and second blades, each having the configuration shown in FIG. 4.

FIG. 8 partially shows a blade of a packing element according to one embodiment of the invention.

Substantially parallel or perpendicular is given to mean a plane that deviates by at most ±20°, or even by at most 10° or by at most 5°, from a parallel or perpendicular plane.

A face is non-planar when it has irregularities, it being understood that a non-planar face can define a surface extending parallel or substantially parallel to a plane.

FIG. 1 partially shows a chamber 1, here a chamber of a stripping device. Here, this chamber is in the shape of a cylinder of axis X. This axis X extends in the vertical direction, that is to say in the direction of gravity. This axis corresponds, in general terms, to a direction of circulation of the fluids inside the chamber.

Inside this chamber 1 there is positioned a packing element 10 the function of which is to promote contact between the fluids circulating inside this chamber, in particular in counter-current fashion.

This packing element 10 comprises at least two stacked stages S1, S2, in particular stacked in a stacking direction which here coincides with the axis X of the chamber. The stacking direction thus corresponds to the direction of circulation of the fluids entering the packing element.

Each stage thus extends between two planes that are advantageously perpendicular to the axis X, and consists of a series of first and second blades that are interleaved and rigidly connected. In FIG. 1, for the sake of clarity, just one stage 51 is shown. In FIG. 2, two stages S1 and S2 are shown. However, the invention is not limited by the number of stages, which can be chosen according to the dimensions of the chamber.

In FIG. 2, the two stacked adjacent stages S1, S2 shown are separated in the stacking direction and rigidly connected by spacers 20.

Embodiment (a) of FIG. 2 shows a packing element 10 formed of two stages S1, S2 of first and second blades, the latter having the same orientation from one stage to the next. In other words, the first blades 12.1i of stage S1 are parallel to the first blades 12′.1i of stage S2, and the second blades 12.2i of stage S1 are parallel to the second blades 12′.2i of stage S2.

In embodiment (b) of FIG. 2, the first and second blades 12′.1i and 12′.2i of the second stage S2 are angularly offset, by rotation about the axis X, with respect to the first and second blades 12.1i and 12.2i of the first stage S1. The invention is likewise not limited by the angle at which adjacent stacked stages S1, S2 intersect.

In FIG. 2, the spacers 20 are shown schematically. These can be plates extending perpendicular to the axis X and rigidly connected at the facing ends of the blades of two stages to be connected, for example by welding, these plates being connected to one another by one or more rods extending along the axis X. The invention is not limited to this embodiment and any other form of spacer can be envisaged. It would for example be possible to provide spacers that permit disassemblable nesting of the stages, by nesting of the male-female type, facilitating both assembly and disassembly of the packing element inside the chamber. The presence of spacers can thus make it possible to facilitate the installation of the packing element and improve the diffusion of fluid within the packing element.

In one variant, not shown, the spacers 20 could be eliminated: the two adjacent stages S1, S2 can then rest directly one on the other.

Each stage consists of a plurality of distinct blades 12 arranged as described below.

A plurality of first blades 12.1 extend parallel to a first direction D1 and define a plurality of first planes spaced apart from one another. In the figure, the first blades 12.1 defining a plane “i” (non-zero integer) are designated by the reference 12.1i. FIG. 1 thus shows three rows of first blades 12.11, 12.12 and 12.13, each row of first blades defining a distinct plane.

A plurality of second blades 12.2 extend parallel to a second direction D2 forming an angle with the first direction D1 and define a plurality of second planes spaced apart from one another. In FIG. 1, the second blades 12.2 defining a plane “i” (non-zero integer) are designated by the reference 12.2i. FIG. 1 thus shows three rows of second blades 12.21, 12.22 and 12.23, each row of second blades defining a distinct plane.

The second direction D2 forms an angle of 60 to 140° with the first direction D1. Preferably, and as shown, each direction D1, D2 forms an angle of 30 to 70° with the direction of the axis X of the chamber; advantageously the same angle is formed between each direction and the axis X.

The invention is not limited by a number of stages, which depends on the dimensions of the chamber that is to receive the packing element and on the dimensions of the blades.

It will be noted that the blades define a volume inside which they are contained. In other words, the blades fit inside a volume, the dimensions of this volume allowing the packing element to be introduced inside the chamber. This volume is generally cylindrical, in other words similar in shape to the internal shape of the chamber. It thus has an axis X that coincides with that of the chamber. This axis X corresponds to a direction of circulation of the fluids entering the packing element. However, the invention is not limited to a particular shape of the volume inside which the blades fit, this shape depending on the shape of the chamber used.

It will be noted that each blade has an elongate shape, the longitudinal direction L of which corresponds to one of the first or second directions D1, D2, and the transverse direction T of which is perpendicular to the longitudinal direction. These directions, longitudinal L and transverse T, of a blade define the plane of the blade. The dimension of the blade in a direction perpendicular to this plane defines its thickness, the value of which is much smaller than its longitudinal and transverse dimensions.

In each first plane i defined by first blades 12.1i, a free space Ei separates two adjacent first blades in a direction perpendicular to the first direction D1. Each free space Ei receives a second blade 12.2i. In FIG. 1, second blades 12.21 are thus interposed between first blades 12.11.

In addition, the first and second blades are rigidly connected to one another so that these blades form an assembly. Since the blades are made from metal sheet, they can be rigidly connected by welding or any other appropriate method, at the point of contact of the blades interleaved in this manner.

In the example, the first and second blades are relatively short so that each first blade is in contact with just one second blade and vice versa. However, the invention is not limited to this arrangement, and each first blade could be in contact with multiple second blades, and vice versa, for example by using longer blades. In general, the interleaved blades shown in FIG. 1 or FIG. 7 are part of one and the same stage. Each stage thus extends between two planes that are advantageously perpendicular to the axis X, and consists of a series of first and second blades that are interleaved and rigidly connected. A packing element according to the invention can then comprise multiple vertically superposed stages resting directly one on the other, in particular with different orientations. The first and second blades of a stage can thus be angularly offset, by rotation about the axis X, with respect to the first and second blades of one or more other stages. This can promote mixing of the fluids and hence contact between these.

According to the invention, at least one stage of the packing element consists of a plurality of distinct perforated blades 12. Each blade 12 then has a plurality of perforations 14.

According to the invention, each perforated blade is chosen from a blade made from stamped metal sheet and a blade made from expanded metal sheet.

In general, the perforations 14 of a blade represent 15 to 95% of the surface area of the blade in the plane of the blade. This surface area of the perforations can vary depending on the method used to produce the blade.

In addition, the shape of the perforations can vary from one blade to the next and from one stage to the next.

A perforated blade made from expanded sheet is thus obtained by cutting and stretching a coil or a plate of metal in a knife press. The surface area of the perforations will therefore depend on the stretching and the length of the cuts. The use of expanded metal sheets makes it possible to increase the efficiency of the packing element while reducing its thickness, its weight and therefore its cost.

Also in general, each perforated blade has at least one non-planar face, this face being defined as a face parallel or substantially parallel to a plane defined by a plurality of blades, in other words to the plane of the blade. In the case of the perforated blades formed from an expanded metal sheet, the non-planar nature of the two faces of the blade is a consequence of the production method, in which the stretching causes deformation of the metal sheet. In the case of the blades formed from a stamped metal sheet, the non-planar nature of one or both faces can also be a consequence of the production method, in particular when the stamped material is not detached from the blade.

FIG. 3 partially shows a perforated blade made from expanded sheet. In the example shown, the perforations 14 form identical hexagons arranged in a honeycomb pattern, in other words each side of a hexagon is shared with an adjacent hexagon. These hexagons can for example be obtained by creating straight, mutually parallel incisions in a transverse direction perpendicular to the longitudinal direction of the blade, these incisions being arranged in a staggered pattern. The perforations then represent 30 to 95% of the surface area of a blade, or even 40 to 95%, 50 to 95% or 40 to 90% of the surface area.

However, the invention is not limited to this shape of the perforations, it being possible to obtain other shapes by modifying the shape and/or the relative positions of the cuts.

As shown in FIG. 8, a perforated blade 12 can thus consist of a central portion 12a made from expanded metal sheet and a frame 12b surrounding the central portion. The frame and the central portion are attached to one another, for example by welding or any other suitable attachment means (riveting, screw connection, etc.). This configuration makes it possible to increase the perforated surface area of the blade while maintaining its mechanical strength. In this case, the perforations 14 can be arranged as described above, or extend over the entire width of the central portion, as shown in FIG. 8.

It will be noted that the perforations, whatever their shape, are preferably spaced apart, in particular regularly, in a longitudinal direction of the blade.

In addition, the adjacent and longitudinally spaced apart perforations can be offset with respect to one another in a transverse direction, perpendicular to the direction of the blade, by a distance smaller than the dimension of a perforation in said transverse direction. In other words, they can partially overlap when seen in the longitudinal direction of the blade. In the examples of FIGS. 3 and 7, the blade is produced so that the direction in which it is stretched corresponds to a direction perpendicular to the direction D1 or D2 in which it will be arranged. In other words, the longitudinal direction of the blade is perpendicular to the direction of stretching during production of the sheet.

FIGS. 4 to 6 show a perforated blade formed from a stamped sheet according to one particular embodiment in which the material stamped to produce the perforations is kept attached to the blade.

As shown more particularly in FIGS. 5 and 6, each perforation 14 is thus topped by a material bridge 16 formed from the material stamped to produce the perforation. This material bridge 16 forms a deflector and connects two opposite edges of the perforation 14, here rectangular in shape. The deflector 16 thus has a profile view that is also rectangular, as shown in FIG. 5. Here, the deflector 16 has a cross section that is curved in the transverse direction, as shown in FIG. 6.

Other shapes of perforation can be created by stamping, but a quadrilateral shape is simpler and easier to produce.

In the example shown, the perforations 14 are distributed, in particular regularly, in the longitudinal direction of the blade; they are also transversely offset by a distance d smaller than the dimension d_perf of a perforation in the transverse direction T of the blade. This means that the deflectors 16 overlap when the blade is viewed along its longitudinal direction, as shown in FIG. 6. It will be further noted that, in the example shown, the deflectors 16 are all arranged on the same side of the blade, and that all the blades are oriented in the same way, as shown in FIG. 6. In other words, the deflectors of first blades 12.1i defining a given plane are located on the same side of said plane, this being the case for each one of the planes defined by a plurality of first blades 12.1i. This is the same for the second blades 12.2i.

In addition, the deflectors 16 of the perforations of the first and second blades are located on the same side of the blades in a direction of the axis X of the chamber, here towards the top of the chamber as shown in FIG. 6.

The chamber shown can be a stripping chamber of an FCC unit. The latter can then comprise one or more packing elements (of two or more stages of blades) arranged spaced apart from one another along the axis X of the chamber. The chamber then also comprises one or more stripping gas distribution devices 22, at least one device of this type being located below the lowest packing element, as shown in FIG. 2, and another distribution device optionally being provided between two packing elements or between two stages spaced apart by spacers.

As previously mentioned, the packing element according to the invention comprises at least one stage of perforated blades. It can also comprise one or more other stages the blades of which are not perforated. These blades can be simple solid, planar plates such as those described in WO200035575A1. The packing element according to the invention can also comprise one or more other stages formed of corrugated solid plates, such as those described in US20190015808 A1.

Whatever the configuration of a stage, it will be noted that the height of a stage is generally of the order of 30 to 50 cm, for example 35 cm.

1.-14. (canceled)

15. A packing element suitable for being positioned inside a chamber to promote contact between fluids circulating inside this chamber, the packing element comprising at least two stacked stages, each stage being formed of a plurality of distinct blades:
a plurality of first blades extend parallel to a first direction (D1) and define a plurality of first planes spaced apart from one another,
a plurality of second blades extend parallel to a second direction (D2) forming an angle with the first direction (D1) and define a plurality of second planes spaced apart from one another,
and in which, in each first plane, a free space separates two adjacent first blades in a direction perpendicular to the first direction and receives a second blade, the first and second blades being rigidly connected to one another,
wherein each distinct blade of at least one stage is perforated and is chosen from a blade made from stamped metal sheet and a blade made from expanded metal sheet.

16. The packing element of claim 15, wherein the perforations of a blade of the at least one stage represents 15% to 95% of the surface area of the blade, this surface area being defined as a surface area parallel or substantially parallel to a plane defined by a plurality of blades.

17. The packing element of claim 15, wherein each perforated blade of the at least one stage has at least one non-planar face, this face being defined as a face parallel or substantially parallel to a plane defined by a plurality of blades.

18. The packing element of claim 15, wherein each perforated blade of the at least one stage comprises one or more of the following features:
the perforations of a given blade are spaced apart regularly in a longitudinal direction of the blade,
the adjacent and longitudinally spaced apart perforations of a given blade are offset with respect to one another in a transverse direction, perpendicular to the direction of the blade, by a distance smaller than the dimension of a perforation in the transverse direction.

19. The packing element of claim 15, wherein each perforated blade of the at least one stage is a blade formed of a part made from expanded metal sheet surrounded by a frame to which it is attached.

20. The packing element of claim 19, wherein the part made from expanded sheet has parallel or substantially parallel perforations that extend in a direction perpendicular to the longitudinal direction of the blade.

21. The packing element of claim 15, wherein each perforated blade of the at least one stage is a blade made from stamped metal sheet, each perforation of which is topped by a deflector formed from the material stamped to produce the perforation and connecting two opposite edges of the perforation, each deflector defining, with the plane of the blade, a passage the axis of which is parallel to the direction in which the blade extends.

22. The packing element of claim 21, wherein the deflectors of a given blade are located on the same side of the blade, or in that the deflectors of blades defining a given plane are located on the same side of the plane.

23. The packing element of claim 21, wherein the perforated blades of the at least one stage are contained in a volume having an axis (X), in that the first and second directions form a predefined angle with the axis (X), and in that the deflectors of the perforations of the first and second blades are located on the same side of the blades in a direction of the axis.

24. The packing element of claim 15, wherein it comprises at least one stage chosen from a stage of blades formed of solid plates and a stage of blades formed of corrugated solid plates.

25. The packing element of claim 15, wherein two stacked adjacent stages rest directly one on the other or are spaced apart from and rigidly connected to one another by spacers.

26. The packing element of claim 15, wherein the first and second blades of a stage are angularly offset, by rotation about a stacking direction, with respect to the first and second blades of one or more other stages.

27. A chamber for bringing into contact fluids circulating in a fluid circulation direction, inside which there is arranged the least one packing element of claim 15, the packing element being arranged so that the first and second directions form a predefined angle with the fluid circulation direction.

28. The chamber of claim 27, in which the chamber is chosen from a chamber of a stripping device of a fluid catalytic cracking unit, and a portion of a pipe from a withdrawal well of a regenerator.
